(19) United States
(12) Patent Application Publication
(10) Pub. No.: US 2021/0247778 A1
(43) Pub. Date: Aug. 12, 2021

(54) Smart Auxiliary Vehicle

(71) Applicant: Todd David Miller, Pepper Pike, OH (US)

(72) Inventor: Todd David Miller, Pepper Pike, OH (US)

(21) Appl. No.: 17/169,436

(22) Filed: Feb. 6, 2021

Related U.S. Application Data
(60) Provisional application No. 62/972,007, filed on Feb. 9, 2020.

(51) Int. Cl. G05D 1/02; B60D 1/62; B60W 10/02; B60W 10/18

(52) U.S. Cl. CPC G05D 1/0295; B60W 10/18; B60W 10/02; B60D 1/62

(57) ABSTRACT

The Smart Auxiliary Vehicle (SAV) is a vehicle that accompanies another vehicle or object, allowing passenger and cargo space to be modular. The principal use of the SAV is modular vehicle transportation for reduction of energy consumption related to transportation. The SAV may or may not have a mechanical connection between it and the vehicle or object it accompanies. When a mechanical connection is not present, various technologies will allow the SAV to move in concert with another vehicle or object. When a mechanical connection is present, propulsion and/or braking systems will also be present, eliminating towing capacity restrictions, and differentiating the SAV from an ordinary trailer. This invention relates to the field of transportation technology.

### DESCRIPTION & BACKGROUND

The Smart Auxiliary Vehicle (SAV) is a vehicle that uses various technologies to accompany another vehicle, object, or person in a fully-autonomous or partially-autonomous way to provide or extend passenger and/or cargo capacity when needed. The primary intended application of the SAV is in energy-efficient automotive transportation, with the goal of significantly reducing carbon emissions and energy consumption to reverse climate change.

Today, people purchase large vehicles to carry more passengers and cargo, but often don't utilize that capacity. These large vehicles consume lots of energy and create pollution. The SAV addresses this problem by making passenger and cargo capacity modular. When less capacity is needed, a driver could drive a 2-seat or 5-seat vehicle that requires less energy (and may have longer range than larger vehicles); when more capacity is needed, the SAV accompanies the primary vehicle (PV).

In addition to lower energy consumption and pollution, the SAV gives drivers more flexibility in choosing their PV. Many drivers prefer the performance, handling and styling of smaller vehicles, such as sedans and coupes. The SAV gives them the freedom to choose such a vehicle without compromising on passenger and cargo capacity.

### DRAWING DESCRIPTIONS

FIG. 1: SAV and PV without a mechanical connection, referenced in Claim 1.

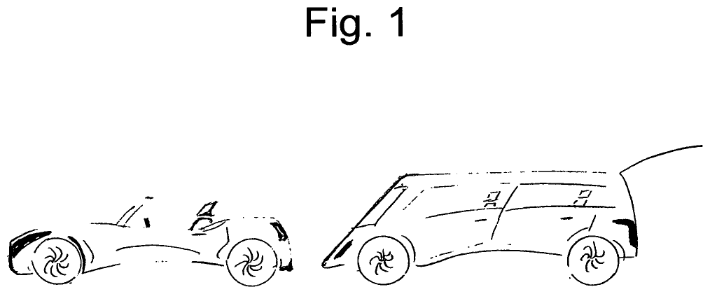

FIG. 2: SAV and PV with a mechanical connection, referenced in Claim 2.

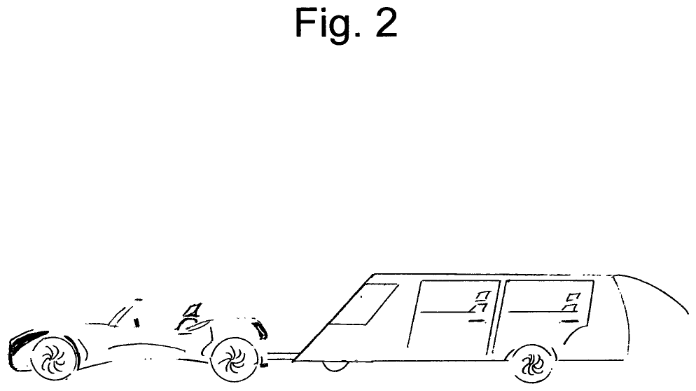

FIG. 3: Cargo-only SAV and PV without a mechanical connection.

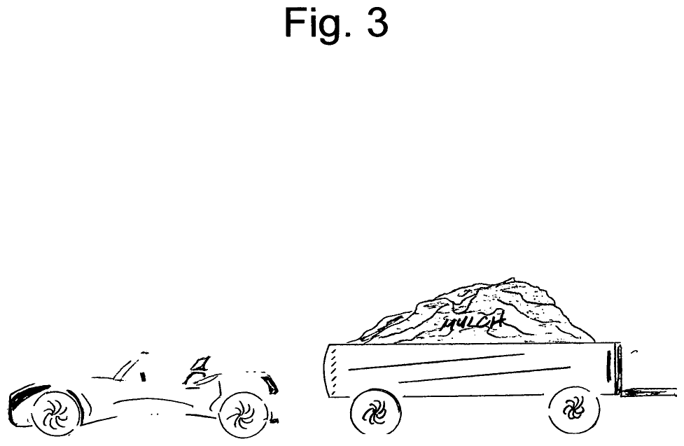

### SAV MODEL TYPES

There are two main model types for the SAV: Touchless Connection (TC) and Mechanical Connection (MC).

Touchless Connection

In the TC model, the SAV accompanies the PV without a mechanical connection. The SAV uses various technologies to monitor and react to the position and movement of the PV. Technologies may include, but are not limited to:
1. GPS
2. Near field communication (NFC)
3. Cameras paired with object recognition software
4. Reference objects and/or transmitters
5. Radar and radar detection
6. Ultrasonic sensors
7. Accelerometer

The TC SAV will include a powertrain, as well as braking and steering systems. One model of the SAV may include the ability to drive the SAV independently, without the PV.

Mechanical Connection

In the MC model, the SAV uses a mechanical connection between the SAV and PV. The PV, via mechanical connection to the SAV, is used to guide the SAV, while the powertrain and braking systems on the SAV propel and slow the SAV in a synchronized fashion with the PV. The powertrain and braking systems eliminate or reduce the towing capacity restrictions commonly found with smaller vehicles, such as sedans.

One model of the MC SAV may include automated connection. Example: When the SAV is within a specified range of the PV, likely determined by GPS, and the driver initiates connection, the SAV uses object recognition or other technology to identify the connection point and positions itself for connection. The MC SAV may have a retractable front wheel with steering capability, enabling proper positioning. Once the SAV is connected, the wheel retracts, such that only the primary wheels are in contact with the ground. When the driver wishes to disconnect the vehicles, the wheel drops to enable disconnection and balance the SAV while disconnected.

Desirable Features

The features noted below aid in describing the utility and functionality of the SAV. The SAV is not limited to these features, nor does the SAV require all noted features.
Solar panel on roof to charge battery, assuming battery power
Backup Assist: Backing with the SAV could be more difficult than with just the PV.

Backup Assist could either back both vehicles automatically or provide the driver with visual and/or audible cues that would help them with backing.
Emergency Stop: In case the TC SAV should “lose sight” of the PV, the SAV will safely pull over, stop and alert the driver.
Audio/video communication between the SAV and PV
Rear hatch to allow for easy loading of cargo
Folding/removable seats that allow for more cargo capacity
Seats that fold to form a bed
Run-flat tires
Airbags, seatbelts and other impact mitigation systems
Entertainment systems
Climate control
Cellular data connection
WiFi

Other Uses

The SAV has other potential uses besides accompanying a 4-wheel automobile. For example, the SAV could accompany a . . .
tractor or other farming equipment
motorcycle or bicycle
person
drone
lawn mower

The features, configuration and design of the SAV for these other uses would be tailored to the application. For example, an SAV that follows a lawn mower might be designed to collect grass clippings or carry tools.

1. I claim a vehicle (V1) comprising passenger and/or cargo space, and technology that enables V1 to accompany another vehicle/object (V2) without a mechanical connection between V1 and V2.

2. I claim a vehicle (V1) comprising passenger and/or cargo space, technology that enables V1 to accompany another vehicle/object (V2) with a mechanical connection between V1 and V2, including braking and/or propulsion systems that enable V1 to move and stop in concert with V2.

3. I claim a system comprising technology used to facilitate control and/or communication between V1 and V2.
